(19) United States
(12) Patent Application Publication
(10) Pub. No.: US 2019/0196967 A1
(43) Pub. Date: Jun. 27, 2019

(54) DEVICE INCLUDING ACCESS CONTROLLER, SYSTEM ON CHIP AND SYSTEM INCLUDING THE SAME

(71) Applicant: Samsung Electronics Co., Ltd., Suwon-si (KR)

(72) Inventor: Jin-hyuck CHOI, Seongnam-si (KR)

(73) Assignee: Samsung Electronics Co., Ltd., Suwon-si (KR)

(21) Appl. No.: 16/233,313

(22) Filed: Dec. 27, 2018

(30) Foreign Application Priority Data
Dec. 27, 2017 (KR) 10-2017-0181520
Oct. 2, 2018 (KR) 10-2018-0117879

(51) Int. Cl. G06F 12/06; G06F 12/14; G06F 21/64

(52) U.S. Cl. CPC G06F 12/0646; G06F 12/1408; G06F 2212/1052; G06F 2212/402; G06F 21/64

(57) ABSTRACT

Provided are a device and a system on chip. A device may include: a plurality of functional blocks comprising a slave block, a first master block, and second master block, wherein the first master block and second master block are configured to selectively access the slave block; a system bus configured to connect the plurality of functional blocks; an access information generator configured to store access setting information received from outside and, based on the access setting information, output access control information; and an access controller configured to, in response to the access control information, determine whether to permit an access from the first master block to the slave block.

### CROSS-REFERENCE TO RELATED APPLICATIONS

This application claims the benefit of Korean Patent Application No. 10-2017-0181520, filed on Dec. 27, 2017, and Korean Patent Application No. 10-2018-0117879, filed on Oct. 2, 2018, in the Korean Intellectual Property Office, the disclosure of which is incorporated herein in its entirety by reference.

### BACKGROUND

The inventive concepts relate to a device, a system on chip (SoC), and a system including the device and the SoC, and more particularly, to a device including an access controller, an SoC, and a system including the device and the SoC.

Internet of Things (IoT) indicates a technology for connecting various things, in which sensors and/or communication functions are embedded, to the Internet. The things may be various embedded systems such as home appliances, mobile devices, and/or wearable computers. The things connected to IoT may be connected via a wired and/or wireless communication interface with distinguishable accessible addresses and each include a sensor for receiving data from an external environment.

Because any object or thing may be subject to hacking, the security of IoT devices is becoming more and more important as IoT develops. In an IoT network system including IoT devices, when at least one of the IoT devices is used by a malicious user, the IoT network system may be compromised.

### SUMMARY

The inventive concepts provide a device including an access controller, and more particularly, a device with improved security and a system including the device.

According to an aspect of the inventive concepts, there is provided a device including: a plurality of functional blocks including a slave block, a first master block, and a second master block, wherein the first master block and the second master block are configured to selectively access the slave block; a system bus configured to connect the plurality of functional blocks; an access information generator configured to store access setting information externally received and, based on the access setting information, output access control information; and an access controller configured to, in response to the access control information, determine whether to permit access from the first master block to the slave block.

According to another aspect of the inventive concepts, there is provided a system on chip including: a plurality of functional blocks including a first functional block, a second functional block, and a third functional block; a system interconnect through which the plurality of functional blocks transmit signals to one another; an access information generator configured to store access setting information externally received and output, based on the access setting information, access control information; and an access information generator configured to, in response to the access control information, determine permission or non-permission of access from the second functional block and the third functional block to the first functional block.

According to yet another aspect of the inventive concepts, there is provided a device including: a plurality of functional blocks including a slave block, a first master block, and a second master block, wherein the first master block and the second master block are configured to selectively access the slave block; a system bus including dynamically configurable channels and configured to connect the plurality of functional blocks via the channels; an access information generator configured to store access setting information including information regarding accesses from the first master block and the second master block to the slave block and output, based on the access setting information, access control information; and an access controller configured to, based on the access control information, determine permission or non-permission of the accesses from the first master block and the second master block to the slave block.

### BRIEF DESCRIPTION OF THE DRAWINGS

Embodiments of the inventive concepts will be more clearly understood from the following detailed description taken in conjunction with the accompanying drawings in which:

FIG. 1 is a block diagram of a system according to an example embodiment;

FIG. 2 is a block diagram of a device according to an example embodiment;

FIG. 3 is a detailed block diagram of an access information generator according to an example embodiment;

FIG. 4 is a detailed block diagram according to an example embodiment;

FIG. 5 is a flowchart of operations performed by a device according to an example embodiment;

FIG. 6 is a flowchart of detailed operations performed by a device according to an example embodiment;

FIG. 7 is a block diagram of a detailed configuration of an access controller according to an embodiment;

FIG. 8 is a flowchart of operations performed by an access controller according to an example embodiment;

FIGS. 9A and 9B respectively are drawings for describing operations performed by an access controller, according to another example embodiment;

FIG. 10 is a block diagram of a device according to another example embodiment;

FIG. 11 is a block diagram of a device according to yet another example embodiment; and

FIG. 12 is a block diagram of an IoT network system including a device according to an example embodiment.

### DETAILED DESCRIPTION OF EXAMPLE EMBODIMENTS

Hereinafter, embodiments of the inventive concepts will be described in detail with reference to attached drawings.

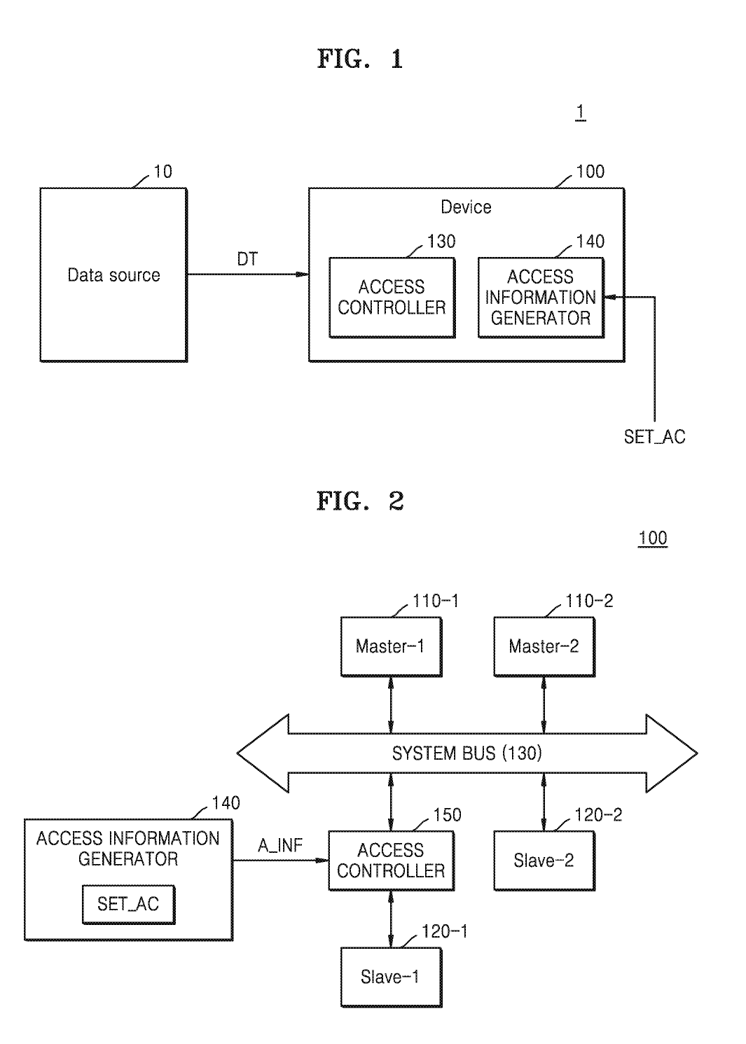

FIG. 1 is a block diagram of a system according to an example embodiment.

Referring to FIG. 1, the system 1 may include a data source 10 and a device 100. For example, the device 100 may be an Internet of Things (IoT) device, and the system 1 may be an IoT system. The device 100 may be an embedded device provided in various things, for example, home appliances, a mobile device, a wearable computer, a vehicle, or the like. The system 1 may be a system in fields of fusion/combination of an information technology (IT) and various industries, for example, fields of smart homes, smart buildings, smart cities, smart vehicles or connected vehicles, smart grids, health care, smart home appliances, advanced medical services, and the like.

The data source 10 may transmit data DT to the device 100. The data source 10 may be a hub, a server, or another IoT device provided in an IoT system. For example, the data source 10 may transmit the data DA to the device 100 by using wireless local area network (WLAN) such as wireless fidelity (Wi-Fi), wireless personal area network (WPAN) such as Bluetooth, a wireless universal serial bus (USB), Zigbee, Near Field Communication (NFC), or radio-frequency identification (RFID). Alternatively, the data source 10 may transmit the data DA to the device 100 by using mobile cellular networks such as 3rd generation (3G) mobile cellular network, 4th generation (4G) mobile cellular network, Long Term Evolution (LTE) mobile cellular network, LTE-Advanced (LTE-A) mobile cellular network, or 5th generation (5G) mobile cellular network.

In an example embodiment, the device 100 may include an access controller 150 and/or an access information generator 140. For example, the device 100 may include a plurality of functional blocks, and the access information generator 140 may store access setting information SET_AC regarding accesses between the functional blocks, which is externally received from outside of the device 100. For example, the user may input the access setting information SET_AC in an operation of mass production of the device 100. However, example embodiments are not limited thereto.

The access information generator 140 may, based on the access setting information SET_AC, output access control information. In an example embodiment, the access controller 150 may, based on the access control information, interrupt access from a certain master block to a certain slave block provided in the device 100. For example, the device 100 may include an external interface as a slave block and an application processor (AP) as a master block, and the access controller 150 may, in response to the access control information output from the access information generator 140, interrupt an access from the AP to the external interface. Details thereof will be described below.

FIG. 2 is a block diagram of the device 100 according to an example embodiment.

Referring to FIG. 2, the device 100 may include a plurality of function blocks 110-1, 110-2, 120-1, and 120-2, a system bus 130, the access information generator 140, and/or the access controller 150. The device 100 may, for example, be a system-on-chip (SoC). For example, each of the function blocks 110-1, 110-2, 120-1, and 120-2 may be implemented in the SoC chip to perform inherent functions of the functional blocks.

The function blocks 110-1, 110-2, 120-1, and 120-2 may be classified into master blocks 110-1 and 110-2 and slave blocks 120-1 and 120-2. The master blocks 110-1 and 110-2 and the slave blocks 120-1 and 120-2 may be classified according to whether the blocks have authority to use the system bus 130. The master blocks 110-1 and 110-2 may, on their own, request data communication to the slave blocks 120-1 and 120-2; on the other hand, the slave blocks 120-1 and 120-2 may perform data communication based on the control of the master blocks 110-1 and 110-2. Alternatively, although not shown, one functional block may serve as both a master block and a slave block. In an example embodiment, each of the number of master block and the number of slave block is two; however, it is merely for convenience of explanation, and the number of master block and the number of slave block may be greater or less than two and different from each other.

The master blocks 110-1 and 110-2 may access the slave blocks 120-1 and 120-2 via the system bus 130. Each of the master blocks 110-1 and 110-2 may, for example, include a central process unit (CPU), an application processor (AP), a graphics processing unit (GPU), a microcontroller, direct memory access (DMA), a digital signal processor (DSP), a universal serial bus (USB), and/or a security engine.

The slave blocks 120-1 and 120-1 may be controlled by the master blocks 110-1 and 110-2 via the system bus 130. Each of the slave blocks 120-1 and 120-2 may, for example, include volatile memory, non-volatile memory, cache memory, a memory controller, a sensor, and/or an interface.

However, the device 100 is not limited thereto and may, as a function block, include a multi-format codec (MFC), a video module (for example, a Joint Photographic Experts Group (JPEG) processor, a video processor, or a mixer), a three-dimensional graphic core, an audio system, a driver, and/or a display driver as a master block and/or a slave block.

The system bus 130 may connect the master blocks 110-1 and 110-2 to the slave blocks 120-1 and 120-2. Alternatively, the system bus 130 may be configured such that the master blocks 110-1 and 110-2 and the slave blocks 120-1 and 120-2 may transmit signals via the system bus 130. Alternatively, the system bus 130 may include dynamically configurable channels and be configured to contact each of the master blocks 110-1 and 110-2 and the slave blocks 120-1 and 120-2. The system bus 130 may also be referred to as a system interconnect. For example, the system bus 130 may include a read address (AR) channel, a write address (AW) channel, a write response (B) channel, a read response (R) channel, and/or a write data (W) channel defined in AXI4 spectrum.

The system bus 130 may be implemented as a bus that employs a protocol having a certain bus standard. For example, as a bus standard, Advanced Microcontroller Bus Architecture (AMBA) protocol of Advanced RISC Machine (ARM) may be employed. A bus type of the AMBA protocol may include Advanced High-Performance Bus (AHB), Advanced Peripheral Bus (APB), Advanced eXtensible Interface (AXI), AXI4, AXI Coherency Extensions (ACE), and the like. Among the above-mentioned bus types, AXI, which is an interface protocol between functional blocks, provides a multiple outstanding address function and a data interleaving function. Different types of protocols, for example, uNetwork of SONICs Inc., CoreConnect of IBM, Open Core Protocol of OCP-IP, and/or the like, may also be used for the system bus 130.

The access information generator 140 may store the access setting information SET_AC regarding accesses between the master blocks 110-1 and 110-2 and the slave blocks 120-1 and 120-2. For example, at the time of the mass production of the device 100, the access setting information SET_AC may be stored in the access information generator 140 by a producer (or a user). In an example embodiment, the access information generator 140 may, based on the access setting information SET_AC, output the access control information A_INF.

In an example embodiment, the access information generator 140 may be a one-time programmable (OTP) memory in which a structure of a memory cell that is a storage unit of data is irreversibly changed. For example, the access information generator 140 may be an OPT memory and the access setting information SET_AS stored in the access information generator 140 may be unchangeable after being recorded once.

However, the example embodiment is merely an example and is not limited thereto. As another example, the access information generator 140 may be non-volatile memory such as electrically erasable programmable read-only memory (EEPROM), flash memory, phase-change random access memory (PRAM), resistive random access memory (RRAM), nano floating gate memory (NFGM), polymer random access memory (PoRAM), magnetic random access memory (MRAM), and/or ferroelectric random access memory (FRAM).

The access controller 150 may receive access control information A_INF. The access controller 150 may, in response to the access control information A_INF, control accesses to the slave blocks 120-1 and 120-2. In an example embodiment, the access controller 150 may be electrically connected between the system bus 130 and the slave block (for example, the slave block 120-1) and may, based on the access control information A_INF, interrupt an access of the master block (for example, the master block 110-1) via the system bus 130.

As another example, the access controller 150 may be provided in the slave block (for example, the slave block 120-1). As yet another example, the access controller 150 may be provided in the system bus 130.

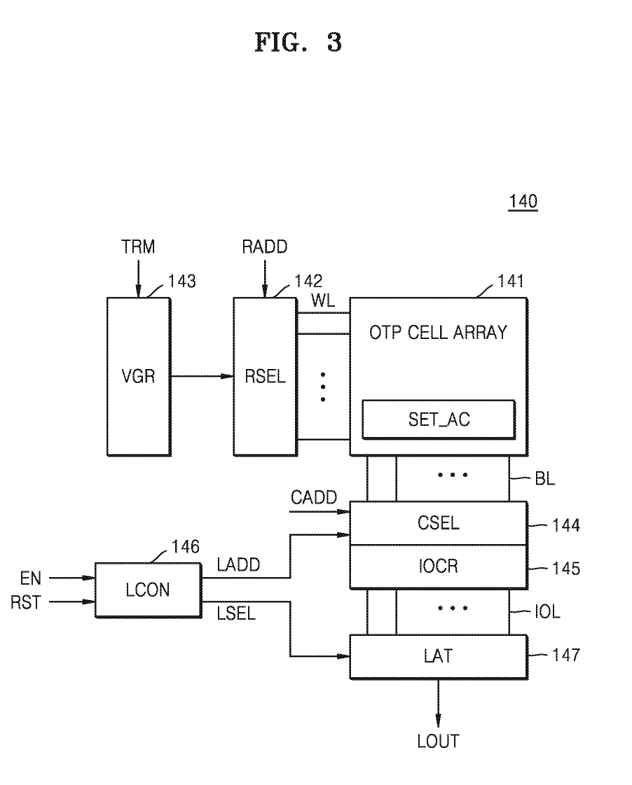

FIG. 3 is a detailed block diagram of an access information generator according to an example embodiment. For example, FIG. 3 may be a detailed block diagram of the access information generator 140 shown in FIG. 2.

Referring to FIG. 3, the access information generator 140 may include an OTP memory cell array 141, a row selection circuit (RSEL) 142, a voltage generator (VGR) 143, a column selection circuit (CSEL) 144, an input/output circuit (IOCR) 145, a latch controller (LCON) 146, and/or a latch circuit (LAT) 147. For example, the access information generator 140 may be an OTP memory device.

The OTP memory cell array 141 may include a plurality of OTP memory cells connected to a corresponding plurality of bit lines BL and a corresponding plurality of word lines WL. Although it is not shown in FIG. 3, the word lines WL may include a voltage word line and/or a read word line.

The OTP memory cell array 141 may include a fuse block and/or a normal block that corresponds to a region other than the fuse block. The fuse block may, for example, store the access setting information SET_AC in fuse bits. The access information generator 140 may, when outputting the access control information A_INF, read the access setting information SET_AC stored in the fuse block.

The RSEL 142 may include a row decoder to select a word line WL corresponding to a row address RADD. The VGR 143 may, based on a trim code TRM, generate at least one internal voltage. For example, the VGR 143 may generate a program voltage, a read voltage, and the like for the OTP memory cell array 141.

The CSEL 144 may include a column gate circuit or a column decoder to select a bit line corresponding to a column address CADD or a latch address LADD. The column decoder may, based on the column address CADD or the latch address LADD, generate column selection signals. The column gate circuit may include a plurality of switches selectively turned on in response to the column selection signals. From among the plurality of switches, a switch corresponding to the column address CADD may be turned-on, and thus, a bit line BL may be selected.

The IOCR 145 may, via the CSEL 144, be connected to the bit lines BL. The IOCR 145 may include a read sense amplifier and/or a write driver. The read sense amplifier may perform a read operation to sense data stored in the OTP memory cell and provide read data. The write driver may perform a write operation to store write data in the OTP memory cell. The write driver may be formed to be integral with the read sense amplifier or may, alternatively, be formed as an extra circuit distinguished from the read sense amplifier.

The LCON 146 may, for example, generate a latch address (LADD) indicating an address that is sequentially changed in an enable mode to initialize the access information generator 140. The LCON 146 may, based on an enable signal EN and a reset signal RST, generate the latch address LADD. The CSEL 144 may, in the enable mode, in response to the latch address LADD, electrically connect some of the bit lines BL to a plurality of input/output lines IOL.

The LAT 147 may, through the input/output lines, sequentially receive and store fuse bits provided via some of bit lines BL in the enable mode. The stored fuse bits may be provided as latch output signals LOUT.

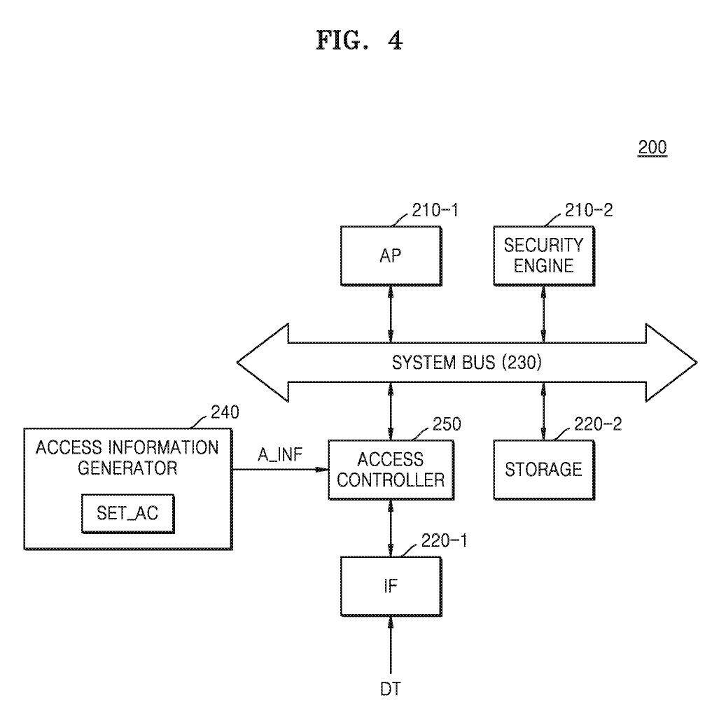

FIG. 4 is a detailed block diagram of a device 200 according to an example embodiment. Descriptions overlapping those of FIG. 2 are omitted.

Referring to FIG. 4, a device 200 may, as master blocks, include an application processor (AP) 210-1 and a security engine 210-2. The AP 210-1 may execute applications providing various contents such as internet browsers, games, videos. The security engine 210-2 may encrypt and/or decrypt data DT received external from the device 200. The security engine 210-2 may maintain security of the data DT by performing an encryption operation based on the encryption algorithm. The encryption algorithm, for example, may be an algorithm that generates encrypted data by using an encryption key. The encryption algorithm may include various algorithm, for example, Message-Digest algorithm (MD5), Secure Hash Algorithm (SHA), Advanced Encryption Standard (AES), Data Encryption Standard (DES), and the like.

In addition, the device 200 may, as slave blocks, include an interface (IF) 220-1 and a storage 220-2. The storage 220-2 may include volatile and/or non-volatile memory. The storage 220-2 may store an instruction or data related to at least another component of the device 200. For example, the storage 220-2 may store software and/or a program. The program may include, for example, kernel, middleware, an application programming interface (API) and/or an application program (or an application), and the like. At least a part of the kernel, the middleware, the API may be referred to as an operation system. The kernel may, for example, control or manage other programs (system resources used to execute operations or functions embodied in the middleware, API, or the application program).

The IF 220-1 may include an external interface like a sensor, or a module including the external interface. The IF 220-1 may be implemented as a wired interface and/or a wireless interface. As another example, the IF 220-1 may include a communication interface. The communication interface may be Local Area Network (LAN), Wireless Local Area Network (WLAN) such as Wi-Fi, Wireless Personal Area Network such as Bluetooth, a wireless Universal Serial Bus (USB), Zigbee, Near Field Communication (NFC), Radio-Frequency Identification (RFID), a programmable logic controller (PLC), a universal asynchronous receiver transmitter (UART), an inter-integrated circuit (I2C), a serial peripheral interface (SPI), or a communication interface that may access a mobile communication network. The IF 220-1 may receive the data DT from the outside of the device 200. In other words, the apparatus 200 may, via the IF 220-1, receive data DA from an external device (for example, the data source 10 shown in FIG. 1).

For example, the data DA may be security data that requires security, and restrictions on accesses to certain functional blocks may be required. In this case, a producer (or an owner) of the device 200 may store information regarding a certain functional block which is restricted in an access to the IF 220-1, as access setting information SET_AC. For example, the storage of the access setting information SET_AC may be irreversibly performed only once but is not limited thereto.

In an example embodiment, the access controller 250 may, based on the access control information A_INF, interrupt an access from a certain functional block to the IF 220-1. For example, based on the access control information A_INF, an access from the application processor 210-1 among the master blocks to the IF 220-1 may be interrupted.

In an example embodiment, when the access setting information SET_AC is stored such that the access from the AP 210-1 to the IF 220-1 is interrupted, the access controller 250 may output a dummy address in response to the access from the AP 210-1. In other words, the access controller 250 may convert an address of the IF 220-1 into the dummy address in response to the access from the AP 210-1 and output the dummy address as a response to the access from the AP 210-1.

In another embodiment, when the access setting information SET_AC is stored such that the access from the application processor 210-1 to the IF 220-1 is interrupted, the access controller 250 may convert a part of an access signal of the AP 210-1. For example, the access signal of the AP 210-1 that is delivered to the IF 220-1 via the system bus 230 may include an access permission bit. In this case, the access controller 250 converts the access permission bit, and thus, the access from the AP 210-1 may be interrupted.

For example, a producer (or a user) of the device 200 may store the access setting information SET_AC such the access to the IF 220-1 is not restricted. In this case, the AP 210-1 may access the IF 220-1 without restriction.

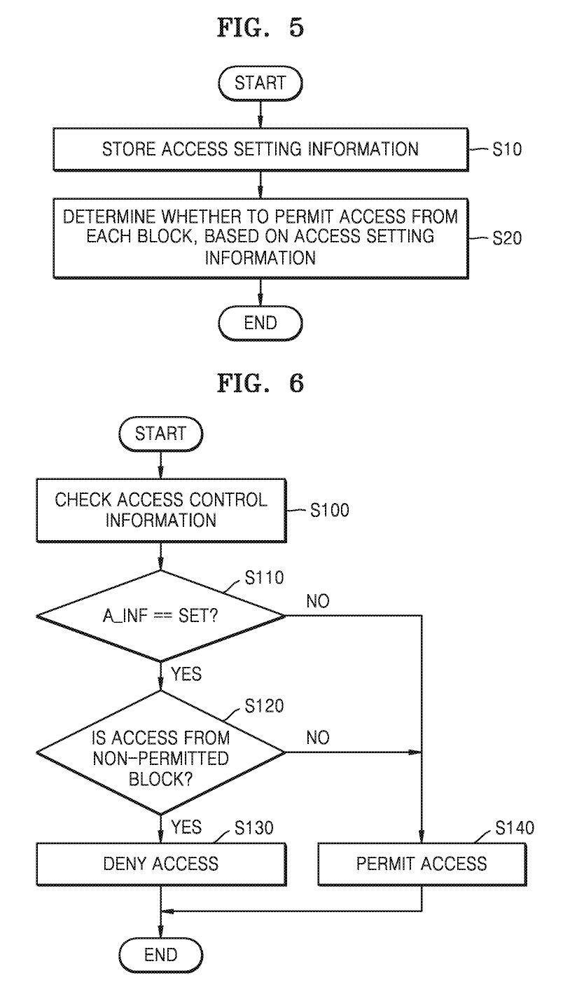

FIG. 5 is a flowchart of operations performed by the device 200 according to an example embodiment. Hereinafter, FIG. 5 is described with reference to FIG. 4.

Referring to FIG. 5, the access setting information SET_AC may be stored in the access information generator 140 (S10). For example, the access setting information SET_AC may be irreversibly stored once in the access information generator 140. The access setting information SET_AC may include information to limit an access from a certain master block to a predetermined (or alternatively, given) slave block provided in the device 200. For example, the access setting information SET_AC may include information that restricts the access from the application processor 210-1 to the IF 220-1.

Next, the device 200 may, based on the access setting information SET_AC, determine whether to permit an access of each block (S20). The access information generator 240 may, based on the access setting information SET_AC, output the access control information A_INF to the access controller 250. For example, the access control information A_INF may include at least one bit indicating whether there is a restriction in access to a certain slave block (for example, the IF 220-1).

FIG. 6 is a flowchart of detailed operations performed by the device 200 according to an example embodiment. Hereinafter, FIG. 6 is described with reference to FIG. 4.

Referring to FIG. 6, the access controller 250 may check the access control information A_INF (S100). The access controller 250 may determine whether the access control information A_INF is set to restrict an access from a certain master block (S110), and when the access control information A_INF is set not to restrict an access from any master block, the access controller 250 may permit the accesses via the system bus 230 (S140).

On the other hand, when the access control information A_INF is set to restrict an access of a certain master block, the access controller 250 may determine whether the access that is received is an access from a non-permitted master block. When the access from the non-permitted master block is received, the access controller 250 may deny the access that is received (S130). On the other hand, when the access is not the access from the non-permitted master block, the access controller 250 may approve the access that is received (S140).

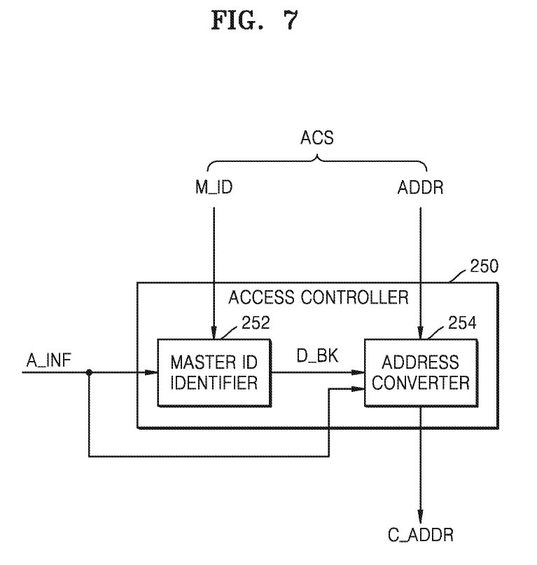

FIG. 7 is a block diagram of a detailed configuration of the access controller 250 according to an example embodiment. FIG. 7 may, for example, illustrate a detailed configuration of the access controller 250 shown in FIG. 4.

Referring to FIG. 7, the access controller 250 may receive access control information A_INF output from the access information generator 240. In addition, the access controller 250 may also receive identification (ID) information M_ID and address information ADDR included in an access signal (ACS) of a certain master block which is delivered through the system bus 230. For example, the ID information may include information for identifying the certain master block that is a subject of the current access. In addition, the address information ADDR may include address information of a slave block (or a target slave block) to which a certain master block, which is a subject of the current access, requested an access.

The access controller 250 may include an ID identifier 252 and/or an address converter 254. In an example embodiment, the ID identifier 252 may receive the access control information A_INF and the ID information M_ID and may, based on the received information, determined whether the subject of the current access is a functional block permitted to access. For example, the access control information A_INF may include a bit indicating information of a functional block which is not permitted to access and whether the functional block is permitted to access or not. The ID identifier 252 may include a comparator and compare the access control information A_INF and the ID information M_ID to each other. Accordingly, the ID identifier 252 may determine whether the subject of the current access is a functional block permitted to access to output a result D_BK of the determination to the address converter 254.

The address converter 254 may receive the access control information A_INF, the address information ADDR, and the result D_BK output from the ID identifier 252 and may, based on the above-mentioned information, interrupt an access from a certain master block. Based on the result D_BK, information indicating that the access is an access from the non-permitted functional block may be delivered to the address converter 254. In addition, by suggesting an access from a master block based on the access control information A_INF, information indicating whether the device is set 200 may be delivered to the address converter 254.

In an example embodiment, the address converter 254 may convert the address information ADDR based on the access control information A_INF and the result D_BK that are received. For example, the address converter 254 may, from the result D_BK and the access control information A_INF, confirm that the access is the access from the non-permitted master block and output a conversion address C_ADDR different from the address information ADDR. The address converter 254 may output the dummy address as the conversion address C_ADDR. The address converter 254 may cause a decoding error of the system bus 230 by outputting the conversion address C_ADDR that is different from the address ADDR.

For example, when the subject of the access is the AP 210-1 and a target slave block, which is an object of the access, is the IF 220-1, an access signal output from the AP 210-1 via the system bus 230 may include the ID information M_ID of the AP 210-1 and the address information ADDR of the IF 220-1. When the access setting information SET_AC is set such that an access from the AP 210-1 to the IF 220-1 is restricted, the ID identifier 252 may, based on the access control information A_INF and the ID information M_ID, confirm that the access is from the AP 210-1 that is restricted from accesses and output a result D_BK of the confirmation to the address converter 254. The address converter 254 may, based on the result D_BK and the access control information A_INF, convert the address information ADDR of the IF 220-1, which is received, to the dummy address. The address converter 254 may output the dummy address as the conversion address C_ADDR.

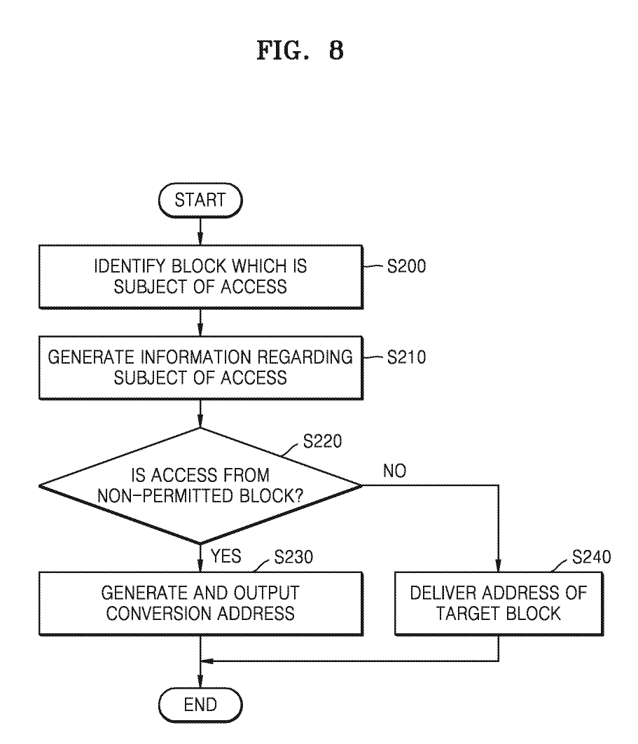

FIG. 8 is a flowchart of operations performed by an access controller according to an embodiment. Hereinafter, FIG. 8 is described with reference to FIG. 7.

Referring to FIG. 8, the access controller 250 may identify the functional block that is a subject of the current access (S200). For example, the access controller 250 may include the ID identifier 252, and the ID identifier 252 may identify the subject of the access, based on the ID information M_ID included in the access signal.

Next, the access controller 250 may generate information regarding the subject of the access (S210). For example, the access controller 250 may, based on the access control information A_INF and the ID information M_ID, generate information regarding whether a function block, which is a subject of the current access, is a functional block restricted from an access to a target slave block that is a current access object. The information regarding the access subject may be generated in the ID identifier 252 and output to the address converter 254.

Next, the access control 250 may determine whether the current access is an access from a functional block that is not permitted to access (S220). When the access is not from the functional block that is not permitted to access, the access controller 250 may deliver the address information, which is received from the system bus 230, to the target block (S240).

When the current access is from the functional block that is not permitted to access, the access controller 250 may generate and output a conversion address C_ADDR (S230). For example, the address converter 254 may output the dummy address as a conversion address C_ADDR for an address of the target slave block. Accordingly, the access controller 250 may cause a decoding error of the system bus 230 to interrupt an access from the functional block that is not permitted to access.

According to the inventive concepts, interruption of an access to a certain functional block may be controlled by including an access information generator and an access controller. Accordingly, without extra circuit configurations, access from a certain functional blocks may be permitted or not permitted according to purpose of the user (or the owner), and thus, a logic circuit for various purposes may be implemented at a lower cost. In addition, the device according to the inventive concepts may reduce or prevent cases in which data requiring high security is received (for example, charged data); for example, the device may interrupt a direct access from an application processor to data input via an interface. By doing so, higher security may be obtained without a high-cost application processor.

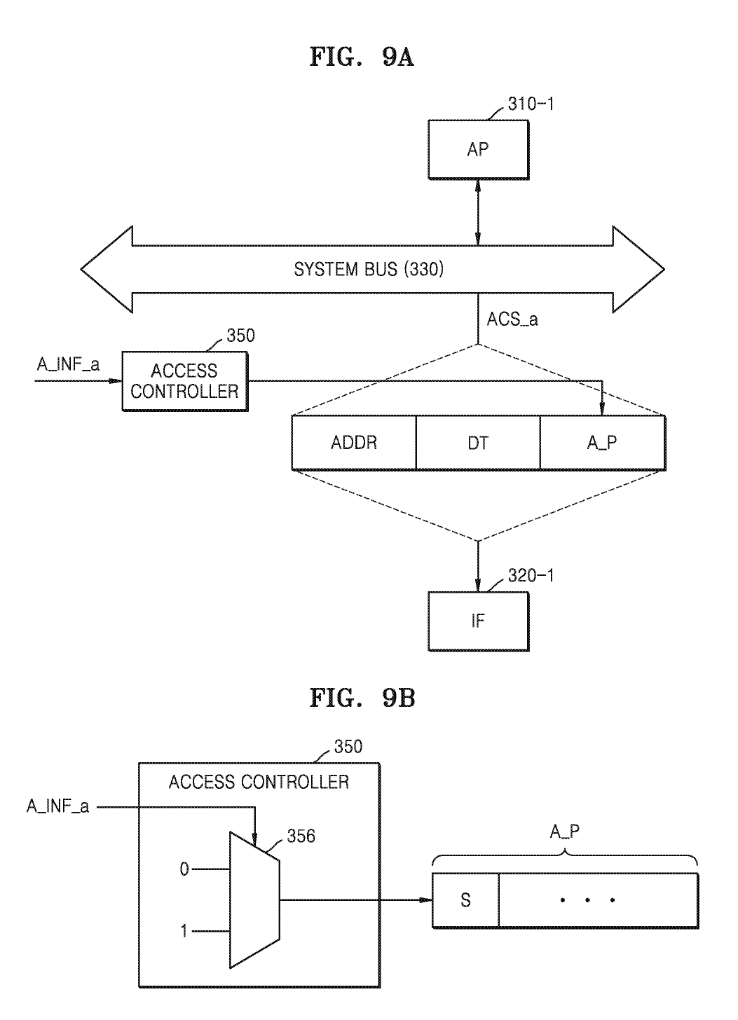

FIGS. 9A and 9B are drawings for describing operations performed by an access controller 310-1 according to another embodiment. In FIGS. 9A and 9B, descriptions overlapping those of FIG. 4 will be omitted.

Referring to FIG. 9A, when a master block, for example, an application processor 310-1 accesses an interface 320-1 as a target slave block, an access signal ACS_a may be output to a system bus 330. The access signal ACS_A may include address information ADDR, data DT, and access permission information A_P. For example, the access permission information A_P may be a basis for determining whether to permit an access from a functional block that is a subject of the access signal ACS_a.

In an example embodiment, the access controller 350 may, in response to the access control information A_INF_a, convert some of the access signals ACS_a. For example, the access controller 350 may, based on the access control information A_INF_a, convert the access permission information A_P. Accordingly, when the access permission information A_P output from the application processor 310-1 is set to correspond to permission, the access controller 350 may, based on the access control information A_INF_a, directly convert the access permission information A_P to correspond to non-permission. By doing so, the access controller 350 may, based on the access control information A_INF_a, restrict the access from the application processor 310-1 to the interface 320-1.

Further referring to FIG. 9B, the access controller 350 may include a multiplexer 356. The multiplexer 356 may receive ‘0’ (or an electric signal corresponding to ‘0’) as a first input and ‘1’ (or an electric signal corresponding to ‘1’) as a second input, and may, based on the access control information A_INF_a, selectively output one of ‘0’ and ‘1’.

The access permission information A_P may include at least one access permission bit S. In an example embodiment, an output from the multiplexer 356 may be applied to the access permission bit S. In other words, the multiplexer 356 may, based on the access control information A_INF_a, convert the access permission bit S.

When the access permission bit S is set to indicate access permission by ‘0’ and access non-permission by ‘1’, the multiplexer 356 may interrupt an access from the application processor 310-1 to the interface 320-1 by outputting ‘1’ based on the access control information A_INF_a. Alternatively, the multiplexer 356 may, by outputting ‘0’ based on the access control information A_INF_a, permit the access from the application processor 310-1 to the interface 320-1.

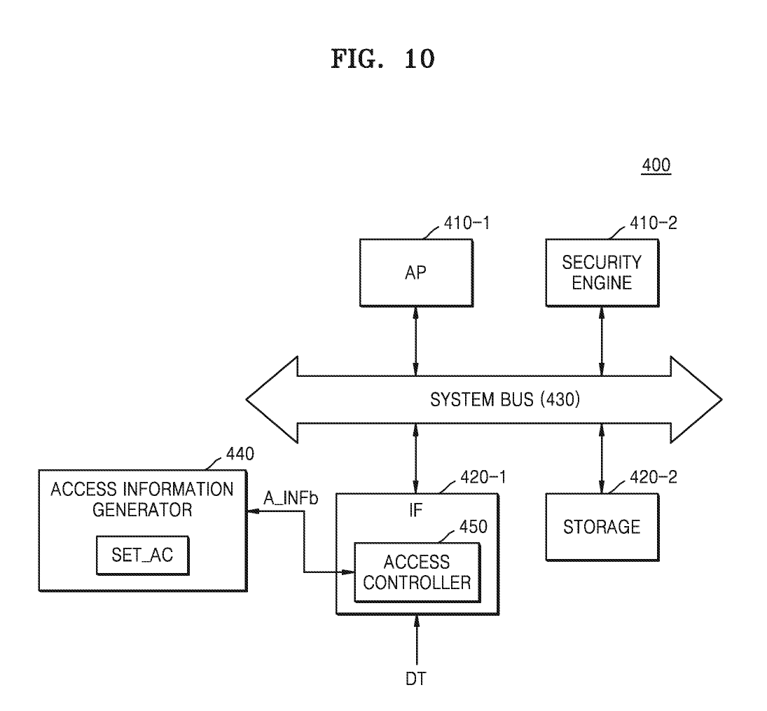

FIG. 10 is a block diagram of a device 400 according to another example embodiment. In FIG. 10, descriptions overlapping those of FIG. 4 will be omitted.

Referring to FIG. 10, an access controller 450 may be provided in an interface 420-1. For example, the access setting information SET_AC stored in the access information generator 440 may be set such that the access from the application processor 410-1 to the interface 420-1 is not permitted. By doing so, the interface 420-1 including the access controller 450 may interrupt the access from the application processor 410-1, based on the access control information A_INF_b output from the access information generator 440. For example, the access setting information SET_AC stored in the access information generator 440 may be set to permit an access from the security engine 410-2 to the interface 420-1. By doing so, the device 400 may, without including additional circuits, selectively control permission/non-permission of the accesses between the functional blocks.

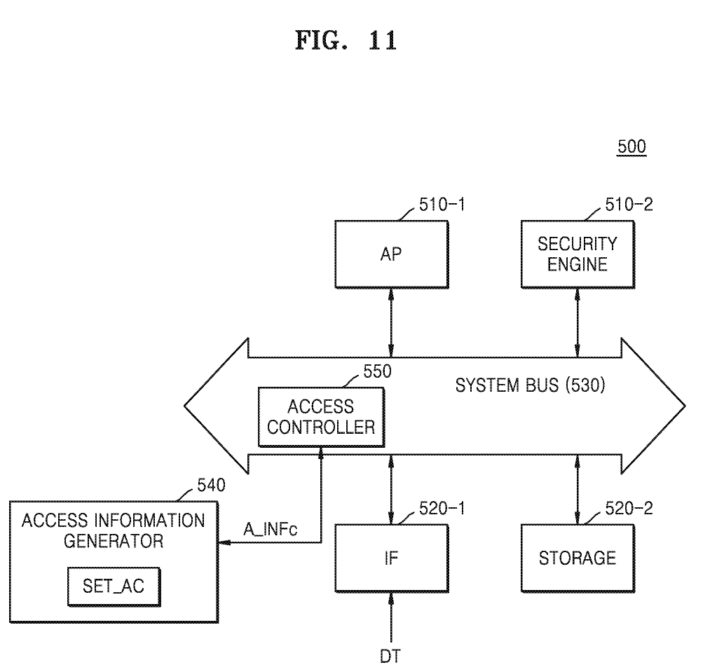

FIG. 11 is a block diagram of a device 500 according to yet another example embodiment. In FIG. 11, descriptions overlapping those of FIG. 4 are omitted.

Referring to FIG. 11, an access controller 550 may be provided in a system bus 530. For example, the access setting information SET_AC stored in the access information generator 540 may be set such that the access from the application processor 510-1 to the interface 520-1 is not permitted. By doing so, the system bus 530 including the access controller 550 may, based on access control information A_INF_c output from the access information generator 540, interrupt the access from the application processor 510-1 to the interface 520-1.

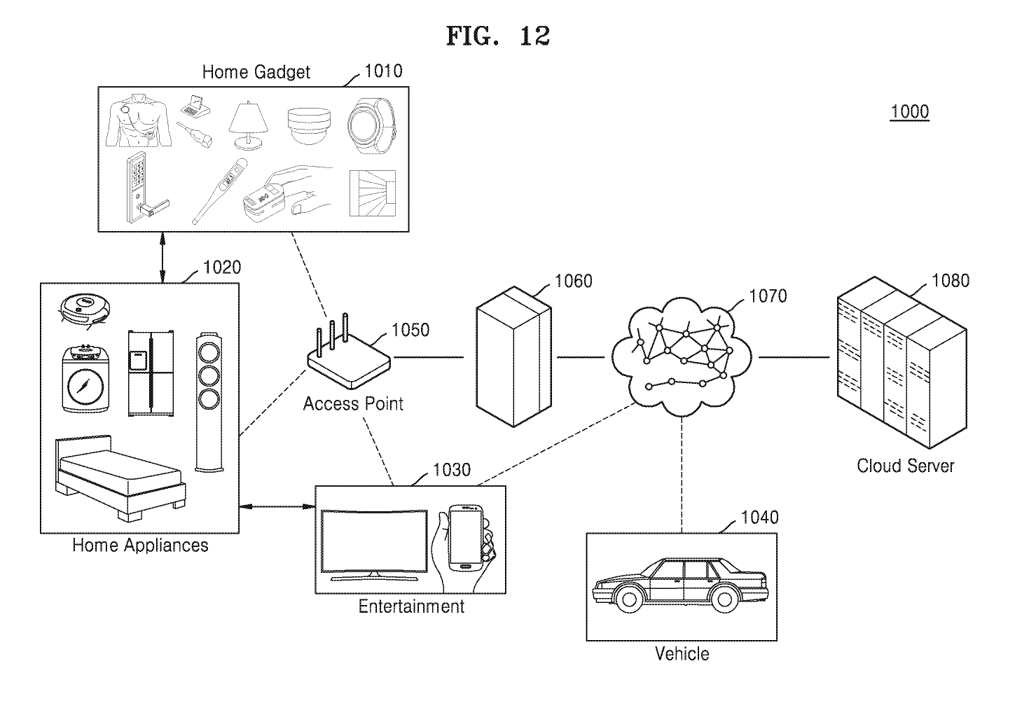

FIG. 12 is a block diagram of an IoT network system including a device, according to an example embodiment. IoT (that is, Internet of Things) may indicate networks between IoT devices 1010, 1020, 1030, and 1040 using wired communication and/or wireless communication. An IoT or IoT network system 1000 may also be named as a Ubiquitous Sensor Network (USN) communication system, a machine type communications (MTC) communication system, a machine-oriented communication (MOC) communication system, a machine-to-machine (M2M) communication system, or a device-to-device (D2D) communication system, and the like.

Referring to FIG. 12, the IoT network system 1000 may include the IoT devices 1010, 1020, 1030, and/or 1040, a hub 1050, a gateway 1060, a communication network 1070, and/or a server 1080. The IoT devices 1010, 1020, 1030, and/or 1040 may be classified into different groups, according to characteristics. For example, the IoT devices 1010, 1020, 1030, and/or 1040 may be grouped into a home gadget group 1010, a home appliances group 1020, an entertainment group 1030, or a vehicle group 1040 respectively. The hub 1060 may function as an access point. The IoT devices 1010, 1020, 1030, and/or 1040 may, via the hub 1050, contact the communication network 1070 or contact each other.

At least one of the IoT devices 1010, 1020, 1030, and/or 1040 may include an interface (for example, the IF 220-1 shown in FIG. 4) and collect data from outside via the interface. According to the inventive concepts, at least one of the IoT devices 1010, 1020, 1030, and/or 1040 may include an access controller (for example, the access controller 250 shown in FIG. 4). Accordingly, at least one of the IoT devices 1010, 1020, 1030, and/or 1040 may, for example, restrict an application processor (for example, the AP 210-1 shown in FIG. 4) from directly accessing the data collected by using the interface. By using the IoT devices 1010, 1020, 1030, and/or 1040, security may be improved at lower cost, and as a result, reliability of the IoT network system may be improved.

The various blocks and/or functional units described above may also include processing circuitry including, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. In some example embodiments, the various blocks and/or functional units described above may be at least one of an application-specific integrated circuit (ASIC) and/or an ASIC chip.

The various blocks and/or functional units described above may be configured as a special purpose machine by executing computer-readable program code stored on a storage device. The program code may include program or computer-readable instructions, software elements, software modules, data files, data structures, and/or the like, capable of being implemented by one or more hardware devices, such as one or more instances of the various blocks and/or functional units described above. Examples of program code include both machine code produced by a compiler and higher level program code that is executed using an interpreter.

The various blocks and/or functional units described above may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism or capable of transmitting data. Such separate computer readable storage medium may include a USB flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium. The computer programs, program code, instructions, or some combination thereof may be communicated between the various blocks and/or functional units described above and a remote computing system via any wireless transmission method, including a near field communication (NFC) link, a wireless network communication link, and/or an ad hoc wireless network communication link. A remote computing system may include a smartphone device. A remote computing system may include a tablet device.

While the inventive concepts have been particularly shown and described with reference to embodiments thereof, it will be understood that various changes in form and details may be made therein without departing from the spirit and scope of the following claims.

What is claimed is:

1. A device comprising:
a plurality of functional blocks comprising a slave block, a first master block, and a second master block, wherein the first master block and the second master block are configured to selectively access the slave block;
a system bus configured to connect the plurality of functional blocks;
an access information generator configured to store access setting information externally received and, based on the access setting information, output access control information; and
an access controller configured to, in response to the access control information, determine whether to permit access from the first master block to the slave block.

2. The device of claim 1,
wherein the access controller is electrically connected between the system bus and the slave block and configured to, based on the access control information, determine whether to permit the access from the first master block, which is delivered via the system bus.

3. The device of claim 1,
wherein the first master block is configured to output an access signal comprising identification (ID) information of the first master block and address information of the slave block, and
the access controller comprises:
an identification (ID) identifier configured to, based on the ID information and the access control information, output a determination regarding whether the first master block is a functional block permitted to access the slave block; and
an address converter configured to, based on the determination, output a conversion address which is generated by converting the address information.

4. The device of claim 3,
wherein the address converter outputs a dummy address as the conversion address.

5. The device of claim 1,
wherein the first master block comprises an application processor.

6. The device of claim 1,
wherein the slave block comprises an interface for receiving data external to of the device.

7. The device of claim 1,
wherein the first master block is configured to output an access signal including access permission information indicating permission and non-permission of accesses to the slave block, and
the access controller is further configured to, in response to the access control information, convert at least some of the access permission information.

8. The device of claim 7,
wherein the access permission information comprises an access permission bit, and
the access controller is further configured to, in response to the access control information, convert the access permission bit.

9. The device of claim 8,
wherein the access controller is further configured to receive a first input and a second input which are different from each other, and
the access controller comprises a multiplexer configured to, in response to the access control information, selectively output one of the first input and the second input as the access permission bit.

10. The device of claim 1,
wherein the access controller is in the slave block.

11. The device of claim 1,
wherein the access controller is in the system bus.

12. The device of claim 1,
wherein the second master block comprises a security engine configured to execute an encryption algorithm, and
the access controller is further configured to, in response to the access control information, permit an access from the second master block to the slave block.

13. The device of claim 1,
wherein the access information generator comprises a one-time programmable (OTP) memory.

14. A system on chip comprising:
a plurality of functional blocks comprising a first functional block, a second functional block, and a third functional block;
a system interconnect through which the plurality of functional blocks transmit signals to one another;
an access information generator configured to store access setting information received externally and output, based on the access setting information, access control information; and
an access controller configured to, in response to the access control information, determine permission or non-permission of access from the second functional block and the third functional block to the first functional block.

15. The system on chip of claim 14,
wherein the access controller is configured to receive an access signal which is output from one of the second functional block and the third functional block and delivered via the system interconnect, and
the access controller is further configured to cause, based on the access signal and the access control information, a decoding error with respect to one of the accesses from the second functional block and the third functional block to the first functional block.

16. The system on chip of claim 15,
wherein the access signal comprises identification (ID) information regarding one of the second functional block and the third functional block and address information of the first functional block, and
the access controller comprises:
an identification (ID) identifier configured to, based on the ID information and the access control information, determine whether a subject of the access signal is a functional block permitted to access the first functional block; and
an address converter configured to, based on the determination, output a conversion address generated by converting the address information.

17. The system on chip of claim 15,
wherein the access signal comprises an access permission bit indicating permission or non-permission of the accesses, and
the access controller converts the access permission bit in response to the access control information.

18. The system on chip of claim 14,
wherein the first functional block comprises an interface.

19. A device comprising:
a plurality of functional blocks comprising a slave block, a first master block, and a second master block, wherein the first master block and the second master block are configured to selectively access the slave block;
a system bus comprising dynamically configurable channels and configured to connect the plurality of functional blocks via the channels;
an access information generator configured to store access setting information comprising information regarding accesses of the first master block and the second master block to the slave block and output, based on the access setting information, access control information; and
an access controller configured to, based on the access control information, determine permission or non-permission of the accesses from the first master block and the second master block to the slave block.

20. A device of claim 19,
wherein the first master block comprises an application processor,
the slave block comprises an interface configured to receive data external to the device, and
the access controller, when determining that an access from the first master block to the slave block is not permitted, causes a decoding error in the access of the first master block.
